(19) United States
(12) Patent Application Publication
(10) Pub. No.: US 2026/0280199 A1
(43) Pub. Date: Sep. 17, 2026

(54) AUTOMOTIVE CONNECTOR

(71) Applicant: HL MANDO CORPORATION, Pyeongtaek-si (KR)

(72) Inventors: Jaehyeong CHO, Pyeongtaek-si (KR); Jihwan KIM, Pyeongtaek-si (KR)

(73) Assignee: HL MANDO CORPORATION, Pyeongtaek-si (KR)

(21) Appl. No.: 19/311,334

(22) Filed: Aug. 27, 2025

(30) Foreign Application Priority Data
Mar. 13, 2025 (KR) 10-2025-0033000

(51) Int. Cl. H01R 13/66; H01R 13/52

(52) U.S. Cl. CPC H01R 13/6683; H01R 13/5202; H01R 13/6691; H01R 2201/26

(57) ABSTRACT

An automotive connector includes a connector main body portion divided into an inner portion and a lower portion. A plurality of terminal receiving grooves is formed in the lower portion by a bottom surface. A plurality of sensing electrodes is disposed alternately at adjacent edges of the inner portion so as to have different polarities between the adjacent edges, penetrates the bottom surface, and extends to the lower portion. A printed circuit board is disposed at the lower portion and is electrically connected to the plurality of sensing electrodes. A controller is electrically connected to the printed circuit board and is configured to identify a resistance value between the plurality of sensing electrodes. When the resistance value is equal to or less than a threshold value, the controller may output a submergence warning signal. This configuration enables early detection of a trace amount of moisture inflow into the connector.

### CROSS-REFERENCE TO RELATED APPLICATIONS

This application claims the priority of Korean Patent Application No. 10-2025-0033000 filed on Mar. 13, 2025, in the Korean Intellectual Property Office, the disclosure of which is incorporated herein by reference.

### BACKGROUND

### Technical Field

The present disclosure relates to an automotive connector.

### Description of the Related Art

A connector plays a vital role in an automotive electrical system, providing an electrical connection between a power pack and a vehicle body.

A waterproof connector for vehicle implements a watertight structure in a connector connection portion and wire fixing portion by applying a rubber seal. This basic watertight structure can provide a certain level of waterproof function under normal use environments.

### BRIEF SUMMARY

In the course of developing the subject matter described herein, it was observed that conventional waterproof connectors lack a structural feature capable of detecting moisture ingress at an early stage. This limitation has been identified as a primary factor inhibiting timely response to abnormal moisture conditions. The present disclosure relates to various embodiments of a connector configured to detect the presence of moisture prior to substantial ingress, thereby enabling early warning and improved reliability.

For example, the automotive connector described includes a moisture detection system integrated within its structure, allowing for early identification of moisture through resistance measurements between sensing electrodes. These electrodes are arranged with alternating polarities and are insert molded into the inner edges of the connector housing. The electrodes are spaced and extended in a transverse manner to detect moisture entry from various directions. A printed circuit board and controller are included in the lower portion of the housing to monitor resistance values between the electrodes and generate warning signals when a threshold is met.

The connector further includes separate electrode groups positioned along the edges and inner surfaces of the housing. The controller evaluates resistance in each group independently and is configured to output different warning signals depending on whether moisture is detected in one or both regions. This configuration enables active monitoring and early response to moisture ingress, distinguishing it from conventional connectors that rely solely on sealing structures and do not provide internal detection or alert capabilities.

One aspect of the present disclosure is to provide an automotive connector capable of early detection of a trace amount of moisture inflow.

According to one aspect of the present disclosure, there is provided an automotive connector including: a connector main body portion divided into an inner portion and a lower portion in which a plurality of terminal receiving grooves is formed by a bottom surface; a plurality of sensing electrodes which is disposed alternately at adjacent edges so as to have different polarities between the adjacent edges of the inner portion, penetrate the bottom surface, and extend to the lower portion; a printed circuit board which is disposed at the lower portion and is electrically connected to the plurality of sensing electrodes; and a controller which is electrically connected to the printed circuit board and is configured to identify a resistance value between the plurality of sensing electrodes.

The controller may output a submergence warning signal when the resistance value between the plurality of sensing electrodes is equal to or less than a threshold value.

The controller may periodically monitor the resistance value between the plurality of sensing electrodes.

A watertight portion may be provided at an upper end of the inner portion, and an upper end of the sensing electrode may be spaced apart from the watertight portion by a distance (in some embodiments, ‘selected’ or ‘predetermined’ distance).

Each of the plurality of sensing electrodes may be insert-molded into the edge.

According to one aspect of the present disclosure, there is provided an automotive connector including: a connector main body portion divided into an inner portion and a lower portion in which a plurality of terminal receiving grooves is formed by a bottom surface; a first sensing electrode and a second sensing electrode which are disposed at each edge of the inner portion, penetrate the bottom surface, and extend to the lower portion; a printed circuit board which is disposed at the lower portion and electrically connected to the first sensing electrode and the second sensing electrode; and a controller which is electrically connected to the printed circuit board and is configured to identify a resistance value between the first sensing electrode and the second sensing electrode.

The controller may output a submergence warning signal when the resistance value between the first sensing electrode and the second sensing electrode is equal to or less than a threshold value.

The controller may periodically monitor the resistance value between the first sensing electrode and the second sensing electrode.

A watertight portion may be provided at an upper end of the inner portion, and upper ends of the first sensing electrode and the second sensing electrode may be spaced apart from the watertight portion by a distance (in some embodiments, ‘selected’ or ‘predetermined’ distance).

Each of the first sensing electrode and the second sensing electrode may be insert-molded into the edge.

The first sensing electrode and the second sensing electrode may be spaced apart from each other by a distance (in some embodiments, ‘selected’ or ‘predetermined’ distance).

The first sensing electrode and the second sensing electrode may include a transverse portion extending horizontally from the bottom surface toward different edges to be spaced apart from the second sensing electrode and the first sensing electrode of the different edges by a distance (in some embodiments, ‘selected’ or ‘predetermined’ distance).

Each of the second sensing electrode and the first sensing electrode of the different edges may include a transverse portion extending horizontally from the bottom surface toward the edge to be spaced apart from the first sensing electrode and the second sensing electrode by a distance (in some embodiments, ‘selected’ or ‘predetermined’ distance).

The transverse portion of the first sensing electrode and the transverse portion of the second sensing electrode at the different edges may be spaced apart from each other by a distance (in some embodiments, ‘selected’ or ‘predetermined’ distance) on the same plane of the inner portion, and the transverse portion of the second sensing electrode and the transverse portion of the first sensing electrode at the different edges may be spaced apart from each other by a distance (in some embodiments, ‘selected’ or ‘predetermined’ distance) on the other same plane of the inner portion.

According to one aspect of the present disclosure, there is provided an automotive connector including: a connector main body portion divided into an inner portion and a lower portion in which a plurality of terminal receiving grooves is formed by a bottom surface; a first sensing electrode group which is disposed in a first region of the inner portion, penetrates the bottom surface, and extends to the lower portion; a second sensing electrode group which is disposed in a second region of the inner portion, penetrates the bottom surface, and extends to the lower portion; a printed circuit board which is disposed in the lower portion and electrically connected to the first sensing electrode group and the second sensing electrode group; and a controller which is electrically connected to the printed circuit board and is configured to identify a submergence state, in which the controller may output a first warning signal when the submergence state is identified in either the first sensing electrode group or the second sensing electrode group, and output a second warning signal when the submergence state is identified in both the first sensing electrode group and the second sensing electrode group.

The first sensing electrode group may include a first sensing electrode and a second sensing electrode disposed at each edge of the inner portion, and the second sensing electrode group may include the first sensing electrode and the second sensing electrode disposed between the edges of the inner portion.

The submergence state may be identified by the controller when a resistance value between the first sensing electrode and the second sensing electrode is equal to or less than a threshold value.

The resistance value between the first sensing electrode and the second sensing electrode may be periodically monitored.

A watertight portion may be provided at the upper end of the inner portion, and upper ends of the first sensing electrode and the second sensing electrode may be spaced apart from the watertight portion by a distance (in some embodiments, ‘selected’ or ‘predetermined’ distance).

The first sensing electrode group may be insert-molded into the edge.

The effects of the present disclosure are not limited to the aforementioned effects, and other effects, which are not mentioned above, will be apparently understood to a person having ordinary skill in the art from the following description.

The technical benefits to be achieved by the present disclosure, the means for achieving the benefits, and the effects of the present disclosure described above do not specify essential features of the claims, and, thus, the scope of the claims is not limited to the disclosure of the present disclosure.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 illustrates a cross-sectional view when an automotive connector according to a first embodiment is viewed from a side surface;

FIGS. 2A and 2B illustrate a plan view when the automotive connector according to the first embodiment is viewed from above and a part of a perspective view when the automotive connector is viewed from an oblique angle;

FIGS. 3A and 3B illustrate a moisture inflow situation according to the disposition form of the automotive connector according to the first embodiment;

FIGS. 4A and 4B illustrate a plan view when an automotive connector according to a second embodiment is viewed from above and a part of a perspective view when the automotive connector is viewed from an oblique angle;

FIGS. 5A and 5B illustrate a moisture inflow situation in the automotive connector according to the second embodiment;

FIGS. 6A and 6B illustrate a part of a perspective view when an automotive connector according to the third embodiment is viewed from an oblique angle, and illustrate a moisture inflow situation;

FIG. 7 illustrates a plan view when an automotive connector according to a fourth embodiment is viewed from above;

FIGS. 8A and 8B illustrate plan views when each situation of moisture inflow in the automotive connector according to the fourth embodiment is viewed from above;

FIG. 9 illustrates a moisture detection operation of an automotive connector according to one embodiment; and

FIG. 10 illustrates a moisture detection operation of an automotive connector according to another embodiment.

### DETAILED DESCRIPTION

Hereinafter, the exemplary embodiment of the present disclosure will be described with reference to the accompanying drawings and exemplary embodiments as follows.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

Like reference numerals refer to like elements throughout the specification. The present specification does not describe all elements of the embodiments, and any content that is general in the technical field to which the present disclosure belongs or that overlaps between the embodiments is omitted. The terms “portion, module, element, or block” used in the specification may be implemented in software or hardware, and according to the embodiments, a plurality of “portions, modules, elements, or blocks” may be implemented as a single element, or a single “portion, module, element, or block” can include a plurality of elements.

Throughout the specification, when a part is said to be “connected” to another part, this includes not only direct connection but also indirect connection, and indirect connection includes connection via a wireless communications network.

To further elaborate, as used herein, the term “connected” is intended to have the broadest possible meaning. Specifically, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The term “coupled” and “in contact” should be interpreted in the same manner.

Additionally, when a part is said to “include” a component, this does not mean that it excludes other components, unless otherwise specifically stated, but rather that it may include other components.

Throughout the specification, when it is said that an element is located “on” another element, this includes not only cases where an element is in contact with another element, but also cases where another element exists between the two elements.

The terms first, second, and the like are used to distinguish one component from another, and the components are not limited by the aforementioned terms.

Singular expressions include plural expressions unless the context clearly indicates otherwise.

The identification codes in each step are used for convenience of explanation and do not describe the order of each step. Each step may be performed in a different order than specified unless the context clearly indicates a specific order.

The working principle and embodiments of the present disclosure will be described with reference to the attached drawings below.

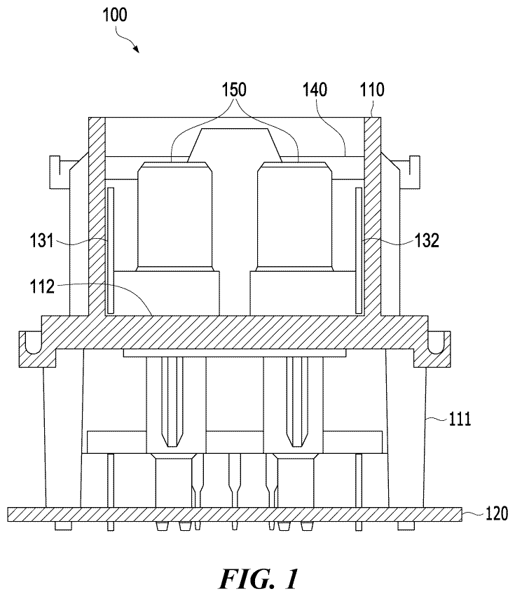

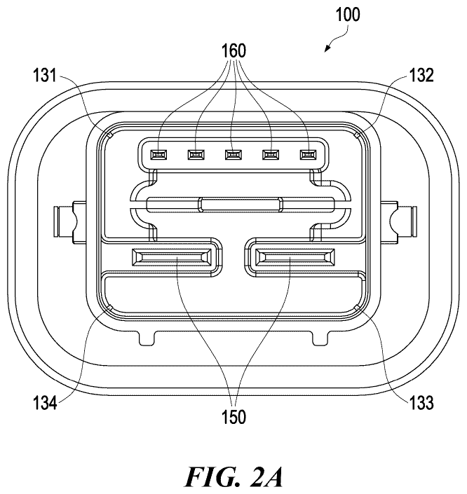

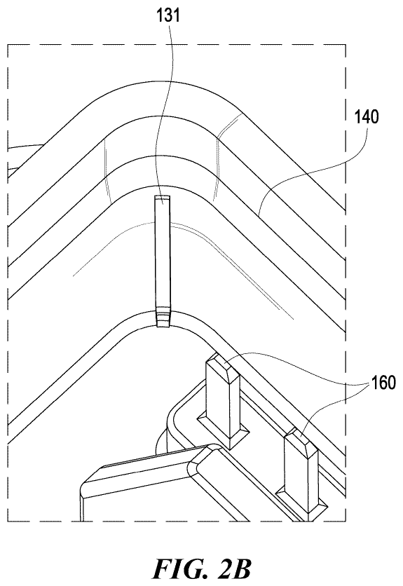

FIG. 1 illustrates a cross-sectional view when an automotive connector according to a first embodiment is viewed from a side surface, and FIGS. 2A and 2B illustrate a plan view when the automotive connector according to the first embodiment is viewed from above and a part of a perspective view when the automotive connector is viewed from an oblique angle.

Referring to FIGS. 1 to 2B, an automotive connector 100 according to the first embodiment may include a connector main body portion 110, a plurality of sensing electrodes 131, 132, 133, and 134, a signal terminal 160, a power terminal 150, a printed circuit board 120, and a controller.

The connector main body portion 110 may be divided into an inner portion and a lower portion 111 in which a plurality of terminal receiving grooves is formed by a bottom surface 112.

A watertight portion 140 may be provided at the upper end of the inner portion of the connector main body portion 110.

The watertight portion 140 may be a rubber sealing material. The watertight portion 140 may be provided for the waterproof function of the automotive connector 100.

The plurality of sensing electrodes 131, 132, 133, and 134 may be disposed alternately at the edges so that they have different polarities between adjacent edges inside, penetrate the bottom surface 112, and extend to the lower portion 111.

For example, the plurality of sensing electrodes 131, 132, 133, and 134 may detect moisture flowing in from any direction by having positive and negative electrodes disposed alternately at each edge.

The upper ends of the plurality of sensing electrodes 131, 132, 133, and 134 may be disposed to be spaced apart from the watertight portion 140 by a distance (in some embodiments, ‘selected’ or ‘predetermined’ distance).

Each of the plurality of sensing electrodes 131, 132, 133, and 134 may be insert-molded into each edge.

The printed circuit board 120 may be disposed on the lower portion 111 of the connector main body and electrically connected to the plurality of sensing electrodes 131, 132, 133, and 134.

The controller may be electrically connected to the printed circuit board 120 and identify the resistance value between the plurality of sensing electrodes 131, 132, 133, and 134.

The controller may output a submergence warning signal when the resistance value between the plurality of sensing electrodes 131, 132, 133, and 134 is equal to or less than a threshold value.

To this end, the controller may periodically monitor the resistance value between the plurality of sensing electrodes 131, 132, 133, and 134.

The automotive connector 100 may include the signal terminal 160 and the power terminal 150, which provide electrical connections between electrical devices within the vehicle.

The signal terminal 160 is for transmitting control signals and data, and may include, for example, a communication line (CL), a sensor signal line (SSL), and a drive signal line (DSL). The communication line is for exchanging data between controllers, and may support a vehicle communication protocol such as a controller area network (CAN), a local interconnect network (LIN), or FlexRay. The sensor signal line transmits information detected from various sensors to the controller, and the drive signal line may transmit a control signal from the controller to an actuator.

The power terminal 150 is for supplying power to electric devices in the vehicle, and may include, for example, a main power terminal (MPT), an auxiliary power terminal (APT), and a ground terminal (GT). The main power terminal receives power directly from the battery and is used as the main operating power of the electric device, and the auxiliary power terminal may control the start and stop of the electric device in conjunction with a key-on signal. The ground terminal may provide a reference potential for circuit operation of the electric device, and may be electrically connected to the negative pole of the vehicle battery and/or the vehicle body.

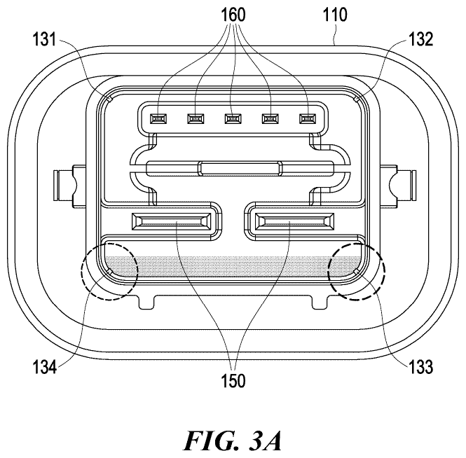

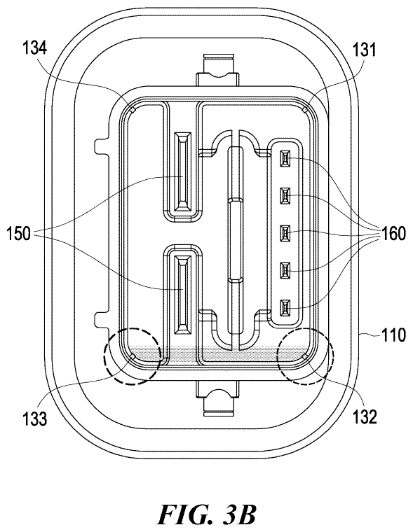

FIGS. 3A and 3B illustrate a moisture inflow situation according to the disposition form of the automotive connector according to the first embodiment.

Referring to FIG. 3A, the automotive connector 100 according to the first embodiment is disposed horizontally.

When moisture flows into the automotive connector 100 as illustrated in FIG. 3A, the resistance value of the sensing electrode 133 and the sensing electrode 134 is reduced by the inflow moisture. In other words, since the sensing electrodes 133 and the sensing electrodes 134 are a pair of positive electrode and negative electrode or a pair of negative electrode and positive electrode, they are electrically connected to each other by the inflow moisture and have high conductivity.

Meanwhile, the controller periodically monitors the resistance value between the sensing electrode 133 and the sensing electrode 134.

The controller outputs the submergence warning signal when the resistance value between the sensing electrode 133 and the sensing electrode 134 is equal to or less than the threshold value.

Referring to FIG. 3b, the automotive connector 100 according to the first embodiment is disposed vertically.

When moisture flows into the automotive connector 100 as illustrated in FIG. 3B, the resistance value of the sensing electrode 132 and the sensing electrode 133 is reduced by the inflow moisture. In other words, since the sensing electrodes 132 and the sensing electrodes 133 are a pair of positive electrode and negative electrode or a pair of negative electrode and positive electrode, they are electrically connected to each other by the inflow moisture and have high conductivity.

Meanwhile, the controller periodically monitors the resistance value between the sensing electrode 132 and the sensing electrode 133.

The controller outputs the submergence warning signal when the resistance value between the sensing electrode 132 and the sensing electrode 133 is equal to or less than the threshold value.

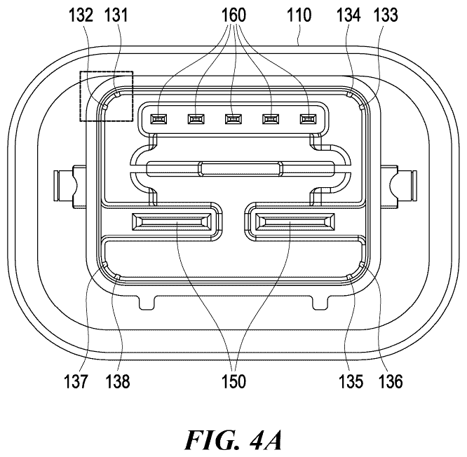

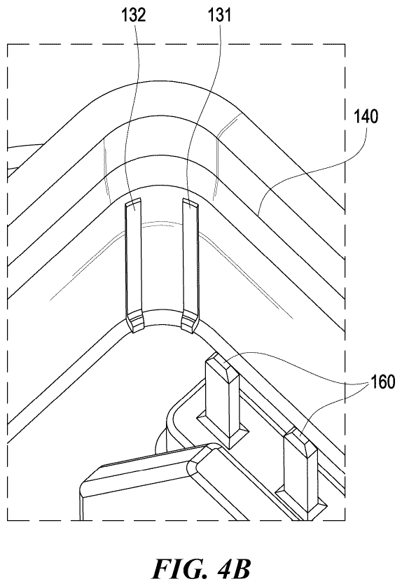

FIGS. 4A and 4B illustrate a plan view when an automotive connector according to a second embodiment is viewed from above and a part of a perspective view when the automotive connector is viewed from an oblique angle.

Referring to FIGS. 4A and 4B, an automotive connector 100 according to the second embodiment may include a connector main body portion 110, a plurality of first sensing electrodes, a plurality of second sensing electrodes, a signal terminal 160, a power terminal 150, a printed circuit board 120, and a controller.

The connector main body portion 110 may be divided into an inner portion and a lower portion 111 in which a plurality of terminal receiving grooves is formed by the bottom surface 112.

A watertight portion 140 may be provided at the upper end of the inner portion of the connector main body portion 110.

The watertight portion 140 may be a rubber sealing material. The watertight portion 140 may be provided for the waterproof function of the automotive connector 100.

A plurality of first sensing electrodes 131, 133, 135, and 137 and a plurality of second sensing electrodes 132, 134, 136, and 138 may be provided in pairs and disposed alternately at the edges so that they have different polarities between adjacent edges inside, penetrate the bottom surface 112, and extend to the lower portion 111.

For example, the plurality of first sensing electrodes 131, 133, 135, and 137 may be positive electrodes, and the plurality of second sensing electrodes 132, 134, 136, and 138 may be negative electrodes. Alternatively, the plurality of first sensing electrodes 131, 133, 135, and 137 may be negative electrodes, and the plurality of second sensing electrodes 132, 134, 136, and 138 may be positive electrodes.

In this way, the plurality of first sensing electrodes 131, 133, 135, and 137 and the plurality of second sensing electrodes 132, 134, 136, and 138 are disposed at the edges to form pairs of positive electrodes and negative electrodes, or pairs of negative electrodes and positive electrodes, so that inflow moisture can be detected regardless of the direction in which the moisture flows in.

More preferably, the pairs of first sensing electrodes 131, 133, 135, and 137 and second sensing electrodes 132, 134, 136, and 138 disposed at each edge of the inner portion of the connector main body portion 110 may be consistently disposed alternately. For example, when the first sensing electrode 131 and the second sensing electrode 132 are disposed at one edge, the sensing electrode at the other edge facing the second sensing electrode 132 is the first sensing electrode 133, and the sensing electrode at another edge facing the first sensing electrode 131 is the second sensing electrode 138.

The upper ends of the plurality of first sensing electrodes 131, 133, 135, and 137 and the plurality of second sensing electrodes 132, 134, 136, and 138 may be disposed so as to be spaced apart from the watertight portion 140 by a distance (in some embodiments, ‘selected’ or ‘predetermined’ distance).

The plurality of first sensing electrodes 131, 133, 135, and 137 and the plurality of second sensing electrodes 132, 134, 136, and 138 may be insert-molded into each edge.

The printed circuit board 120 may be disposed on the lower portion 111 of the connector main body and electrically connected to the plurality of first sensing electrodes 131, 133, 135, and 137 and the plurality of second sensing electrodes 132, 134, 136, and 138.

The controller may be electrically connected to the printed circuit board 120 and identify the resistance values between the plurality of first sensing electrodes 131, 133, 135, and 137 and the plurality of second sensing electrodes 132, 134, 136, and 138.

The controller may output a submergence warning signal when the resistance values between the plurality of first sensing electrodes 131, 133, 135, and 137 and the plurality of second sensing electrodes 132, 134, 136, and 138 are equal to or less than a threshold value.

To this end, the controller may periodically monitor the resistance values between the plurality of first sensing electrodes 131, 133, 135, and 137 and the plurality of second sensing electrodes 132, 134, 136, and 138.

The automotive connector 100 may include the signal terminal 160 and the power terminal 150, which provide electrical connections between electrical devices within the vehicle.

The signal terminal 160 is for transmitting control signals and data, and may include, for example, a communication line (CL), a sensor signal line (SSL), and a drive signal line (DSL). The communication line is for exchanging data between controllers, and may support a vehicle communication protocol such as a controller area network (CAN), a local interconnect network (LIN), or FlexRay. The sensor signal line transmits information detected from various sensors to the controller, and the drive signal line may transmit a control signal from the controller to an actuator.

The power terminal 150 is for supplying power to electric devices in the vehicle, and may include, for example, a main power terminal (MPT), an auxiliary power terminal (APT), and a ground terminal (GT). The main power terminal receives power directly from the battery and is used as the main operating power of the electric device, and the auxiliary power terminal may control the start and stop of the electric device in conjunction with a key-on signal. The ground terminal may provide a reference potential for circuit operation of the electric device, and may be electrically connected to the negative pole of the vehicle battery and/or the vehicle body.

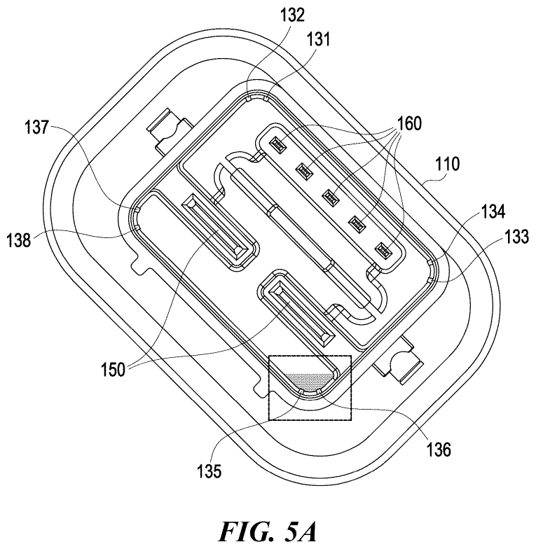

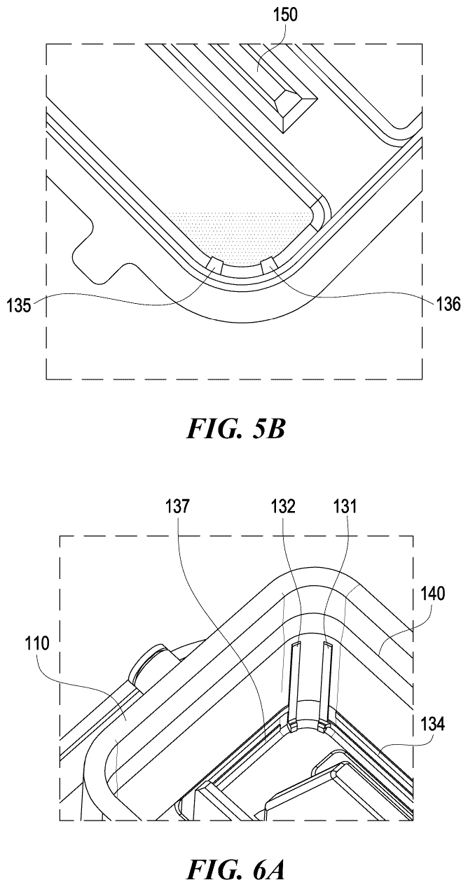

FIGS. 5A and 5B illustrate a moisture inflow situation in the automotive connector according to the second embodiment.

Referring to FIGS. 5A and 5B, some moisture has entered one edge of the automotive connector 100 according to the second embodiment.

When moisture flows into the automotive connector 100 as illustrated in FIGS. 5A and 5B, the resistance value of the first sensing electrode 135 and the second sensing electrode 136 is reduced by the inflow moisture. In other words, since the first sensing electrode 135 and the second sensing electrode 136 are a pair of positive electrode and negative electrode or a pair of negative electrode and positive electrode, they are electrically connected to each other by the inflow moisture and have high conductivity.

Meanwhile, the controller periodically monitors the resistance value between the first sensing electrode 135 and the second sensing electrode 136.

The controller outputs the submergence warning signal when the resistance value between the first sensing electrode 135 and the second sensing electrode 136 is equal to or less than the threshold value.

The automotive connector 100 may include the signal terminal 160 and the power terminal 150, which provide electrical connections between electrical devices within the vehicle.

The signal terminal 160 is for transmitting control signals and data, and may include, for example, a communication line (CL), a sensor signal line (SSL), and a drive signal line (DSL). The communication line is for exchanging data between controllers, and may support a vehicle communication protocol such as a controller area network (CAN), a local interconnect network (LIN), or FlexRay. The sensor signal line transmits information detected from various sensors to the controller, and the drive signal line may transmit a control signal from the controller to an actuator.

The power terminal 150 is for supplying power to electric devices in the vehicle, and may include, for example, a main power terminal (MPT), an auxiliary power terminal (APT), and a ground terminal (GT). The main power terminal receives power directly from the battery and is used as the main operating power of the electric device, and the auxiliary power terminal may control the start and stop of the electric device in conjunction with a key-on signal. The ground terminal may provide a reference potential for circuit operation of the electric device, and may be electrically connected to the negative pole of the vehicle battery and/or the vehicle body.

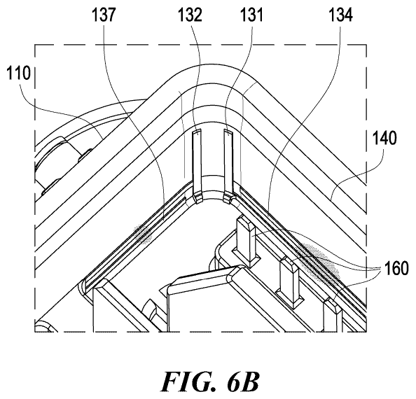

FIGS. 6A and 6B illustrate a part of a perspective view when an automotive connector according to the third embodiment is viewed from an oblique angle, and illustrate a moisture inflow situation.

Referring to FIGS. 6A and 6B, an automotive connector 100 according to a third embodiment may include a connector main body portion 110, a plurality of first sensing electrodes 131, 133, 135, and 137, a plurality of second sensing electrodes 132, 134, 136, and 138, a signal terminal 160, a power terminal 150, a printed circuit board 120, and a controller.

The connector main body portion 110 may be divided into an inner portion and a lower portion 111 in which a plurality of terminal receiving grooves is formed by the bottom surface 112.

A watertight portion 140 may be provided at the upper end of the inner portion of the connector main body portion 110.

The watertight portion 140 may be a rubber sealing material. The watertight portion 140 may be provided for the waterproof function of the automotive connector 100.

The plurality of first sensing electrodes 131, 133, 135, and 137 and the plurality of second sensing electrodes 132, 134, 136, and 138 may be disposed alternately at the edges so that they have different polarities between adjacent edges inside, penetrate the bottom surface 112, and extend to the lower portion 111.

For example, the plurality of first sensing electrodes 131, 133, 135, and 137 may be positive electrodes, and the plurality of second sensing electrodes 132, 134, 136, and 138 may be negative electrodes. Alternatively, the plurality of first sensing electrodes 131, 133, 135, and 137 may be negative electrodes, and the plurality of second sensing electrodes 132, 134, 136, and 138 may be positive electrodes.

In this way, the plurality of first sensing electrodes 131, 133, 135, and 137 and the plurality of second sensing electrodes 132, 134, 136, and 138 are disposed at each edge to form pairs of positive electrodes and negative electrodes, or pairs of negative electrodes and positive electrodes, so that inflow moisture can be detected regardless of the direction in which the moisture flows in.

For example, the pairs of first sensing electrodes 131, 133, 135, and 137 and second sensing electrodes 132, 134, 136, and 138 disposed at each edge of the inner portion of the connector main body portion 110 may be consistently disposed alternately. For example, when the first sensing electrode 131 and the second sensing electrode 132 are disposed at one edge, the sensing electrode at the other edge facing the second sensing electrode 132 is the first sensing electrode 133, and the sensing electrode at another edge facing the first sensing electrode 131 is the second sensing electrode 138.

The upper ends of the plurality of first sensing electrodes 131, 133, 135, and 137 and the plurality of second sensing electrodes 132, 134, 136, and 138 may be disposed so as to be spaced apart from the watertight portion 140 by a distance (in some embodiments, ‘selected’ or ‘predetermined’ distance).

The plurality of first sensing electrodes 131, 133, 135, and 137 and the plurality of second sensing electrodes 132, 134, 136, and 138 may be insert-molded into each edge.

The printed circuit board 120 may be disposed on the lower portion 111 of the connector main body and electrically connected to the plurality of first sensing electrodes 131, 133, 135, and 137 and the plurality of second sensing electrodes 132, 134, 136, and 138.

The controller may be electrically connected to the printed circuit board 120 and identify the resistance values between the plurality of first sensing electrodes 131, 133, 135, and 137 and the plurality of second sensing electrodes 132, 134, 136, and 138.

The controller may output a submergence warning signal when the resistance values between the plurality of first sensing electrodes 131, 133, 135, and 137 and the plurality of second sensing electrodes 132, 134, 136, and 138 are equal to or less than a threshold value.

To this end, the controller may periodically monitor the resistance values between the plurality of first sensing electrodes 131, 133, 135, and 137 and the plurality of second sensing electrodes 132, 134, 136, and 138.

The first sensing electrodes 131, 133, 135, and 137 and the second sensing electrodes 132, 134, 136, and 138 disposed at each edge are spaced apart from each other by a distance (in some embodiments, ‘selected’ or ‘predetermined’ distance).

For example, the first sensing electrodes 131, 133, 135, and 137 and the second sensing electrodes 132, 134, 136, and 138 may include transverse sections extending horizontally from the bottom surface 112 toward different edges to be spaced apart from the second sensing electrode and the first sensing electrode of the different edges by a distance (in some embodiments, ‘selected’ or ‘predetermined’ distance).

Referring to FIG. 6A, the first sensing electrode 131 includes a transverse portion extending horizontally from the bottom surface 112 toward the edge where the second sensing electrode 134 is disposed. The second sensing electrode 134 includes a transverse portion extending horizontally from the bottom surface 112 toward the edge where the first sensing electrode 131 is disposed.

In this case, the transverse portion of the first sensing electrode 131 may be disposed to be spaced apart from the transverse portion of the second sensing electrode 134 by a distance (in some embodiments, ‘selected’ or ‘predetermined’ distance). Similarly, the transverse portion of the second sensing electrode 134 may be disposed to be spaced apart from the transverse portion of the first sensing electrode 131 by a distance (in some embodiments, ‘selected’ or ‘predetermined’ distance).

In the case of FIG. 6A, the transverse portion of the first sensing electrode 131 may be provided in a state in which the transverse portion comes into contact with the bottom surface 112, and the transverse portion of the second sensing electrode 134 may be provided at a higher position than the transverse portion of the first sensing electrode 131 so as not to come into contact with the transverse portion of the first sensing electrode 131. However, the present disclosure is not limited thereto, and the transverse portion of the second sensing electrode 134 may be provided in a state in which the transverse portion comes into contact with the bottom surface 112, and the transverse portion of the first sensing electrode 131 may be provided at a higher position than the transverse portion of the second sensing electrode 134 so as not to come into contact with the transverse portion of the second sensing electrode 134.

The transverse portion of the first sensing electrode 131 may be provided such that the end portion of the transverse portion is spaced apart from the second sensing electrode 134 by a distance (in some embodiments, ‘selected’ or ‘predetermined’ distance). Similarly, the transverse portion of the second sensing electrode 134 may be provided such that the end portion of the transverse portion is spaced apart from the first sensing electrode 131 by a distance (in some embodiments, ‘selected’ or ‘predetermined’ distance).

In contrast, the second sensing electrode 132 disposed at the same edge as the first sensing electrode 131 includes a transverse portion extending horizontally from the bottom surface 112 toward another edge at which the first sensing electrode 137 is disposed. The first sensing electrode 137 includes a transverse portion extending horizontally from the bottom surface 112 toward the edge at which the second sensing electrode 132 is disposed.

In this case, the transverse portion of the second sensing electrode 132 may be provided to be spaced apart from the transverse portion of the first sensing electrode 137 by a distance (in some embodiments, ‘selected’ or ‘predetermined’ distance). Similarly, the transverse portion of the first sensing electrode 137 may be provided to be spaced apart from the transverse portion of the second sensing electrode 132 by a distance (in some embodiments, ‘selected’ or ‘predetermined’ distance).

In the case of FIG. 6A, the transverse portion of the first sensing electrode 137 may be provided in a state in which the transverse portion comes into contact with the bottom surface 112, and the transverse portion of the second sensing electrode 132 may be provided at a higher position than the transverse portion of the first sensing electrode 137 so as not to come into contact with the transverse portion of the first sensing electrode 137. However, the present disclosure is not limited thereto, and the transverse portion of the second sensing electrode 132 may be provided in a state in which the transverse portion comes into contact with the bottom surface 112, and the transverse portion of the first sensing electrode 137 may be provided at a higher position than the transverse portion of the second sensing electrode 132 so as not to come into contact with the transverse portion of the second sensing electrode 132.

The transverse portion of the first sensing electrode 137 may be provided such that the end portion of the transverse portion is spaced apart from the second sensing electrode 132 by a distance (in some embodiments, ‘selected’ or ‘predetermined’ distance). Similarly, the transverse portion of the second sensing electrode 132 may be provided such that the end portion of the transverse portion is spaced apart from the first sensing electrode 137 by a distance (in some embodiments, ‘selected’ or ‘predetermined’ distance).

The printed circuit board 120 may be disposed on the lower portion 111 of the connector main body and electrically connected to the plurality of first sensing electrodes 131, 133, 135, and 137 and the plurality of second sensing electrodes 132, 134, 136, and 138.

The controller may be electrically connected to the printed circuit board 120 and identify the resistance values between the plurality of first sensing electrodes 131, 133, 135, and 137 and the plurality of second sensing electrodes 132, 134, 136, and 138.

The controller may output a submergence warning signal when the resistance values between the plurality of first sensing electrodes 131, 133, 135, and 137 and the plurality of second sensing electrodes 132, 134, 136, and 138 are equal to or less than a threshold value.

To this end, the controller may periodically monitor the resistance values between the plurality of first sensing electrodes 131, 133, 135, and 137 and the plurality of second sensing electrodes 132, 134, 136, and 138.

Referring to FIG. 6B, moisture flows into a middle portion where the transverse portion of the first sensing electrode 131 and the transverse portion of the second sensing electrode 134 intersect, and into a middle portion where the transverse portion of the second sensing electrode 132 and the transverse portion of the first sensing electrode 137 intersect.

When the moisture flows into the automotive connector 100 as illustrated in FIG. 6B, the resistance value of the first sensing electrode 131 and the second sensing electrode 134 is reduced due to the inflow moisture. In other words, since the first sensing electrode 131 and the second sensing electrode 134 are a pair of positive electrode and negative electrode or a pair of negative electrode and positive electrode, they are electrically connected to each other by the inflow moisture and have high conductivity.

Likewise, the resistance value of the second sensing electrode 132 and the first sensing electrode 137 is reduced by the inflow moisture. In other words, since the second sensing electrode 132 and the first sensing electrode 137 are a pair of positive electrode and negative electrode or a pair of negative electrode and positive electrode, they are electrically connected to each other by the inflow moisture and have high conductivity.

The controller periodically monitors the resistance value between the first sensing electrode 131 and the second sensing electrode 134.

The controller outputs the submergence warning signal when the resistance value between the first sensing electrode 131 and the second sensing electrode 134 is equal to or less than the threshold value.

The controller periodically monitors the resistance value between the second sensing electrode 132 and the first sensing electrode 137.

The controller outputs the submergence warning signal when the resistance value between the second sensing electrode 132 and the first sensing electrode 137 is equal to or less than the threshold value.

The automotive connector 100 may include the signal terminal 160 and the power terminal 150, which provide electrical connections between electrical devices within the vehicle.

The signal terminal 160 is for transmitting control signals and data, and may include, for example, a communication line (CL), a sensor signal line (SSL), and a drive signal line (DSL). The communication line is for exchanging data between controllers, and may support a vehicle communication protocol such as a controller area network (CAN), a local interconnect network (LIN), or FlexRay. The sensor signal line transmits information detected from various sensors to the controller, and the drive signal line may transmit a control signal from the controller to an actuator.

The power terminal 150 is for supplying power to electric devices in the vehicle, and may include, for example, a main power terminal (MPT), an auxiliary power terminal (APT), and a ground terminal (GT). The main power terminal receives power directly from the battery and is used as the main operating power of the electric device, and the auxiliary power terminal may control the start and stop of the electric device in conjunction with a key-on signal. The ground terminal may provide a reference potential for circuit operation of the electric device, and may be electrically connected to the negative pole of the vehicle battery and/or the vehicle body.

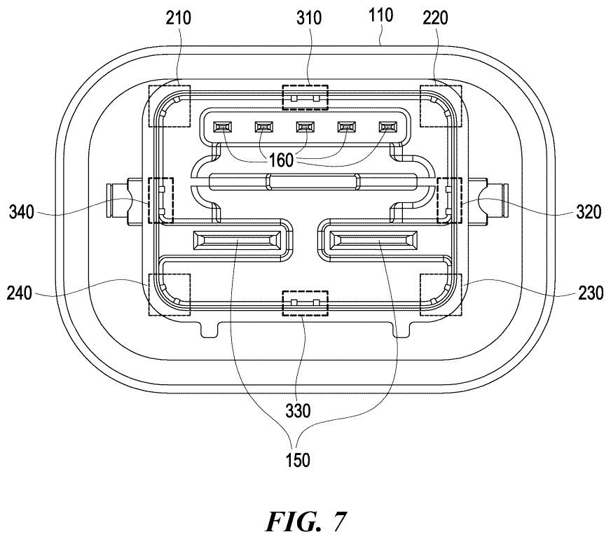

FIG. 7 illustrates a plan view when an automotive connector according to a fourth embodiment is viewed from above.

Referring to FIG. 7, an automotive connector 100 according to the fourth embodiment may include a connector main body portion 110, first sensing electrode groups 210, 220, 230, and 240, second sensing electrode groups 310, 320, 330, and 340, a signal terminal 160, a power terminal 150, a printed circuit board 120, and a controller.

The connector main body portion 110 may be divided into an inner portion and a lower portion 111 in which a plurality of terminal receiving grooves is formed by the bottom surface 112.

A watertight portion 140 may be provided at the upper end of the inner portion of the connector main body portion 110.

The watertight portion 140 may be a rubber sealing material. The watertight portion 140 may be provided for the waterproof function of the automotive connector 100.

The first sensing electrode groups 210, 220, 230, and 240 may be disposed in a first region of the inner portion, penetrate the bottom surface 112, and extend to the lower portion 111. Here, the first region may include each edge of the inner portion of the connector main body.

For example, the first region may include a first edge region 210, a second edge region 220, a third edge region 230, and a fourth edge region 240.

The first sensing electrode groups 210, 220, 230, and 240 may include a plurality of first sensing electrodes 211, 221, 231, and 241 and a plurality of second sensing electrodes 212, 222, 232, and 242. The plurality of first sensing electrodes 211, 221, 231, and 241 and the plurality of second sensing electrodes 212, 222, 232, and 242 included in the first sensing electrode groups 210, 220, 230, and 240 may be provided in pairs and disposed alternately at the edges so that they have different polarities between adjacent edges inside, penetrate the bottom surface 112, and extend to the lower portion 111.

The plurality of first sensing electrodes 211, 221, 231, and 241 and the plurality of second sensing electrodes 212, 222, 232, and 242 included in the first sensing electrode groups 210, 220, 230, and 240 may be insert-molded into each edge.

The second sensing electrode groups 310, 320, 330, and 340 may be disposed in the second region inside and may penetrate the bottom surface 112 to extend to the lower portion 111. Here, the second region may include a space between the edges of the inner portion of the connector main body. In other words, the second region may mean a region excluding the edge of the inner surface of the connector main body. More preferably, the second region may mean a central portion of each inner surface of the connector main body.

For example, the second region may include a first inner surface region 310, a second inner surface region 320, a third inner surface region 330, and a fourth inner surface region 340.

The second sensing electrode groups 310, 320, 330, and 340 may include a plurality of first sensing electrodes 311, 321, 331, and 341 and a plurality of second sensing electrodes 312, 322, 332, and 342. The plurality of first sensing electrodes 311, 321, 331, and 341 and the plurality of second sensing electrodes 312, 322, 332, and 342 included in the second sensing electrode groups 310, 320, 330, and 340 may be disposed in pairs in the second region so as to have different polarities, penetrate the bottom surface 112, and extend to the lower portion 111.

The upper ends of the first sensing electrode groups 210, 220, 230, and 240 and the second sensing electrode groups 310, 320, 330, and 340 may be disposed so as to be spaced apart from the watertight portion 140 by a distance (in some embodiments, ‘selected’ or ‘predetermined’ distance).

The printed circuit board 120 may be disposed on the lower portion 111 of the connector main body and electrically connected to the first sensing electrode groups 210, 220, 230, and 240 and the second sensing electrode groups 310, 320, 330, and 340.

The controller may be electrically connected to the printed circuit board 120 and identify the resistance values between the plurality of first sensing electrodes 211, 221, 231, and 241 and the plurality of second sensing electrodes 212, 222, 232, and 242 of the first sensing electrode groups 210, 220, 230, and 240 and between the plurality of first sensing electrodes 311, 321, 331, and 341 and the plurality of second sensing electrodes 312, 322, 332, and 342 of the second sensing electrode groups 310, 320, 330, and 340.

The controller may output a first warning signal when the resistance values between the plurality of first sensing electrodes 131, 133, 135, and 137 and the plurality of second sensing electrodes 212, 222, 232, and 242 of the first sensing electrode groups 210, 220, 230, and 240 are equal to or less than a threshold value, or when the resistance values between the plurality of first sensing electrodes 311, 321, 331, and 341 and the plurality of second sensing electrodes 312, 322, 332, and 342 of the second sensing electrode groups 310, 320, 330, and 340 are equal to or less than a threshold value.

The controller may output a first warning signal when the resistance values between the plurality of first sensing electrodes 131, 133, 135, and 137 and the plurality of second sensing electrodes 212, 222, 232, and 242 of the first sensing electrode groups 210, 220, 230, and 240 are equal to or less than the threshold value, and when the resistance values between the plurality of first sensing electrodes 311, 321, 331, and 341 and the plurality of second sensing electrodes 312, 322, 332, and 342 of the second sensing electrode groups 310, 320, 330, and 340 are equal to or less than the threshold value.

To this end, the controller may periodically monitor the resistance values between the plurality of first sensing electrodes 131, 133, 135, and 137 and the plurality of second sensing electrodes 212, 222, 232, and 242 of the first sensing electrode groups 210, 220, 230, and 240, and the resistance values between the plurality of first sensing electrodes 311, 321, 331, and 341 and the plurality of second sensing electrodes 312, 322, 332, and 342 of the second sensing electrode groups 310, 320, 330, and 340.

The automotive connector 100 may include the signal terminal 160 and the power terminal 150, which provide electrical connections between electrical devices within the vehicle.

The signal terminal 160 is for transmitting control signals and data, and may include, for example, a communication line (CL), a sensor signal line (SSL), and a drive signal line (DSL). The communication line is for exchanging data between controllers, and may support a vehicle communication protocol such as a controller area network (CAN), a local interconnect network (LIN), or FlexRay. The sensor signal line transmits information detected from various sensors to the controller, and the drive signal line may transmit a control signal from the controller to an actuator.

The power terminal 150 is for supplying power to electric devices in the vehicle, and may include, for example, a main power terminal (MPT), an auxiliary power terminal (APT), and a ground terminal (GT). The main power terminal receives power directly from the battery and is used as the main operating power of the electric device, and the auxiliary power terminal can control the start and stop of the electric device in conjunction with a key-on signal. The ground terminal may provide a reference potential for circuit operation of the electric device, and may be electrically connected to the negative pole of the vehicle battery and/or the vehicle body.

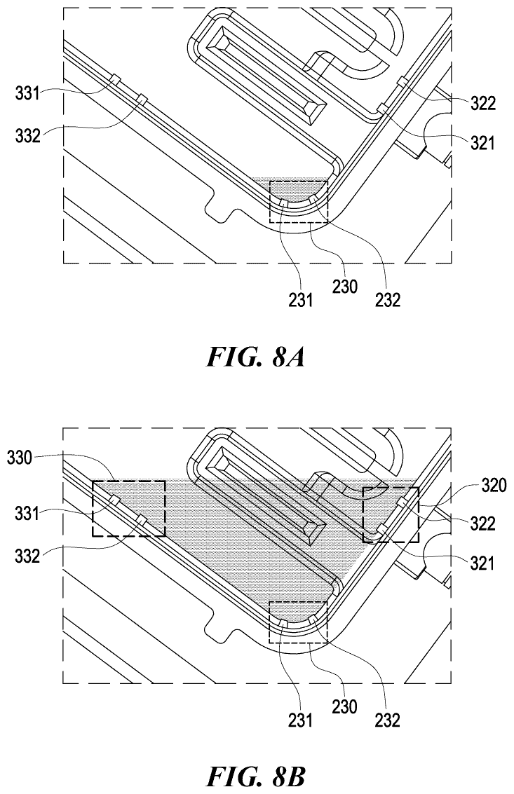

FIGS. 8A and 8B illustrate plan views when each situation of moisture inflow in the automotive connector according to the fourth embodiment is viewed from above.

Referring to FIG. 8A, moisture flows into the third edge region 230 where the first sensing electrode 231 and the second sensing electrode 232 among the first sensing electrode groups 210, 220, 230, and 240 are disposed.

In this case, the resistance value of the first sensing electrode 231 and the second sensing electrode 232 is reduced due to the inflow moisture. In other words, since the first sensing electrode 231 and the second sensing electrode 232 are a pair of positive electrode and negative electrode or a pair of negative electrode and positive electrode, they are electrically connected to each other due to the inflow moisture and have high conductivity.

Meanwhile, the controller periodically monitors the resistance values of the first sensing electrode groups 210, 220, 230, and 240 and the second sensing electrode groups 310, 320, 330, and 340.

The controller outputs a first warning signal when the submergence state is identified in either the first sensing electrode groups 210, 220, 230, and 240 or the second sensing electrode groups 310, 320, 330, and 340. For example, the controller outputs the first warning signal when the resistance value between the first sensing electrode 231 and the second sensing electrode 232 is equal to or less than a threshold value.

Referring to FIG. 8B, moisture flows in across the second inner surface region 320 and the third inner surface region 330 in the second region and the third edge region 230 in the first region.

In this case, the first sensing electrode 321 and the second sensing electrode 322 disposed in the second inner surface region 320, the first sensing electrode 231 and the second sensing electrode 232 disposed in the third edge region 230, and the first sensing electrode 331 and the second sensing electrode 332 disposed in the third inner surface region 330 have their resistance values reduced by the inflow moisture. In other words, since the first sensing electrodes 231, 321, and 331 and the second sensing electrodes 232, 322, and 332 are pairs of positive electrodes and negative electrodes or pairs of negative electrodes and positive electrodes, they are electrically connected to each other due to the inflow moisture and have high conductivity.

Meanwhile, the controller periodically monitors the resistance values of the first sensing electrode groups 210, 220, 230, and 240 and the second sensing electrode groups 310, 320, 330, and 340.

The controller outputs the first warning signal when the submergence state is identified in either the first sensing electrode groups 210, 220, 230, and 240 or the second sensing electrode groups 310, 320, 330, and 340, and outputs the second warning signal when the submergence state is identified in both the first sensing electrode groups 210, 220, 230, and 240 and the second sensing electrode groups 310, 320, 330, and 340. For example, in the case of FIG. 8B, the controller outputs the second warning signal because the resistance value between the first sensing electrode 231 and the second sensing electrode 232 of the first sensing electrode groups 210, 220, 230, and 240 is equal to or less than the threshold value, and the resistance value between each of the first sensing electrodes 321 and 331 and each of the second sensing electrodes 322 and 332 of the second sensing electrode groups 310, 320, 330, and 340 is equal to or less than the threshold value.

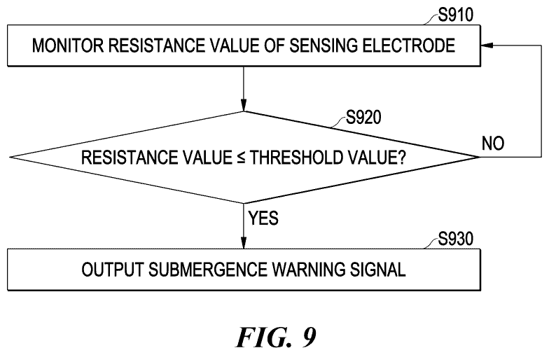

FIG. 9 illustrates the moisture detection operation of the automotive connector 100 according to one embodiment.

The moisture detection operation of the automotive connector according to FIG. 9 includes monitoring the resistance value between the sensing electrodes (S910), determining whether the resistance value between the sensing electrodes is equal to or less than the threshold value (S920), and outputting the submergence warning signal when the resistance value between the sensing electrodes is equal to or less than the threshold value (Yes in S920) (S930).

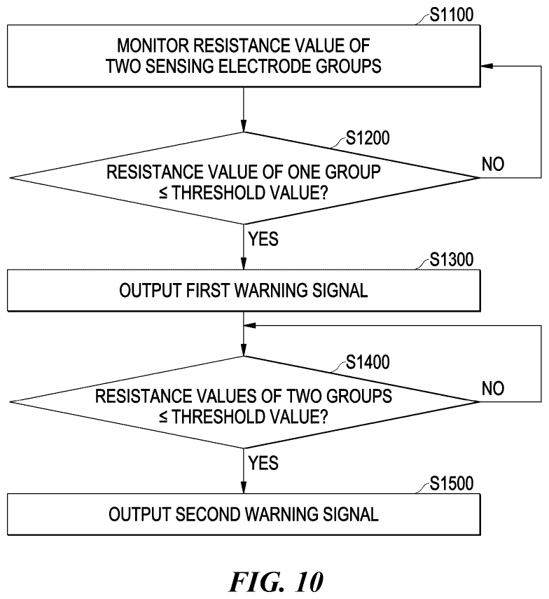

FIG. 10 illustrates a moisture detection operation of an automotive connector according to another embodiment.

The moisture detection operation of the automotive connector according to FIG. 10 includes monitoring the resistance values of two sensing electrode groups (S1100), outputting the first warning signal when the resistance value of any one of the two sensing electrode groups is equal to or less than the threshold value(Yes in S1200) (S1300), and outputting the second warning signal when the resistance values of the two sensing electrode groups are equal to or less than the threshold value (Yes in S1400) (S1500).

The above description is merely an illustrative description of the technical idea of the present disclosure, and those skilled in the art will appreciate that various modifications and variations may be made without departing from the essential characteristics of the present disclosure. Accordingly, the embodiments disclosed in the present disclosure are not intended to limit the technical idea of the present disclosure but to explain it, and the scope of the technical idea of the present disclosure is not limited by these embodiments. The protection scope of the present disclosure should be interpreted by the following claims, and all technical ideas within a scope equivalent thereto should be interpreted as being included in the scope of the rights of the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. An automotive connector comprising:
a connector main body portion divided into an inner portion and a lower portion in which a plurality of terminal receiving grooves is defined by a bottom surface;
a plurality of sensing electrodes which are disposed alternately at adjacent edges of the inner portion of the connector main body portion, so as to have different polarities between the adjacent edges of the inner portion, penetrate the bottom surface, and extend to the lower portion;
a printed circuit board which is disposed at the lower portion and is electrically connected to the plurality of sensing electrodes; and
a controller which is electrically connected to the printed circuit board and is configured to identify a resistance value between the plurality of sensing electrodes.

2. The automotive connector according to claim 1, wherein the controller is configured to output a submergence warning signal based on the resistance value between the plurality of sensing electrodes being equal to or less than a threshold value.

3. The automotive connector according to claim 1, wherein the controller is configured to periodically monitor the resistance value between the plurality of sensing electrodes.

4. The automotive connector according to claim 1, wherein a watertight portion is provided at an upper end of the inner portion, and
wherein an upper end of a sensing electrode of the plurality of sensing electrodes is spaced apart from the watertight portion by a distance.

5. The automotive connector according to claim 1, wherein each of the plurality of sensing electrodes is insert-molded into respective edges of the inner portion.

6. An automotive connector comprising:
a connector main body portion divided into an inner portion and a lower portion in which a plurality of terminal receiving grooves is defined by a bottom surface;
a first sensing electrode and a second sensing electrode which are disposed at each edge of the inner portion of the connector main body portion, penetrate the bottom surface, and extend to the lower portion;
a printed circuit board which is disposed at the lower portion and electrically connected to the first sensing electrode and the second sensing electrode; and
a controller which is electrically connected to the printed circuit board and is configured to identify a resistance value between the first sensing electrode and the second sensing electrode.

7. The automotive connector according to claim 6, wherein the controller is configured to output a submergence warning signal based on the resistance value between the first sensing electrode and the second sensing electrode being equal to or less than a threshold value.

8. The automotive connector according to claim 6, wherein the controller is configured to periodically monitor the resistance value between the first sensing electrode and the second sensing electrode.

9. The automotive connector according to claim 6, wherein a watertight portion is provided at an upper end of the inner portion, and
wherein an upper end of each of the first sensing electrode and the second sensing electrode are spaced apart from the watertight portion by a distance.

10. The automotive connector according to claim 6, wherein each of the first sensing electrode and the second sensing electrode is insert-molded into a respective edge.

11. The automotive connector according to claim 6, wherein the first sensing electrode and the second sensing electrode are spaced apart from each other by a distance.

12. The automotive connector according to claim 6, wherein the first sensing electrode and the second sensing electrode include a transverse portion extending horizontally from the bottom surface toward different edges to be spaced apart from the second sensing electrode and the first sensing electrode of the different edges by a distance.

13. The automotive connector according to claim 12, wherein each of the second sensing electrode and the first sensing electrode of the different edges includes a transverse portion extending horizontally from the bottom surface toward the edge to be spaced apart from the first sensing electrode and the second sensing electrode by a distance.

14. The automotive connector according to claim 13, wherein the transverse portion of the first sensing electrode and the transverse portion of the second sensing electrode at the different edges are spaced apart from each other by a distance on the same plane of the inner portion, and the transverse portion of the second sensing electrode and the transverse portion of the first sensing electrode at the different edges are spaced apart from each other by a distance on the other same plane of the inner portion.

15. An automotive connector comprising:
a connector main body portion divided into an inner portion and a lower portion in which a plurality of terminal receiving grooves is defined by a bottom surface;
a first sensing electrode group which is disposed in a first region of the inner portion, penetrates the bottom surface, and extends to the lower portion;
a second sensing electrode group which is disposed in a second region of the inner portion, penetrates the bottom surface, and extends to the lower portion;
a printed circuit board which is disposed in the lower portion and electrically connected to the first sensing electrode group and the second sensing electrode group; and
a controller which is electrically connected to the printed circuit board and is configured to identify a submergence state,
wherein the controller is configured to output a first warning signal when the submergence state is identified in either the first sensing electrode group or the second sensing electrode group, and output a second warning signal when the submergence state is identified in both the first sensing electrode group and the second sensing electrode group.

16. The automotive connector according to claim 15, wherein the first sensing electrode group includes a first sensing electrode and a second sensing electrode disposed at each edge of the inner portion, and
wherein the second sensing electrode group includes the first sensing electrode and the second sensing electrode disposed between the edges of the inner portion.

17. The automotive connector according to claim 16, wherein the submergence state is identified by the controller based on a resistance value between the first sensing electrode and the second sensing electrode being equal to or less than a threshold value.

18. The automotive connector according to claim 16, wherein the resistance value between the first sensing electrode and the second sensing electrode is periodically monitored.

19. The automotive connector according to claim 16, wherein a watertight portion is provided at the upper end of the inner portion, and
wherein an upper end of each of the first sensing electrode and the second sensing electrode are spaced apart from the watertight portion by a distance.

20. The automotive connector according to claim 16, wherein the first sensing electrode group is insert-molded into respective edges of the inner portion.
